(19) United States
(12) Patent Application Publication
(10) Pub. No.: US 2026/0061377 A1
(43) Pub. Date: Mar. 5, 2026

(54) MIXER

(71) Applicant: SINTOKOGIO, LTD., Nagoya-shi (JP)

(72) Inventor: Masanori SHIMIZU, Aichi (JP)

(73) Assignee: SINTOKOGIO, LTD., Nagoya-shi (JP)

(21) Appl. No.: 19/310,479

(22) Filed: Aug. 26, 2025

(30) Foreign Application Priority Data
Aug. 30, 2024 (JP) 2024-148620

(51) Int. Cl. B01F 27/2123; B01F 27/07; B01F 27/50

(52) U.S. Cl. CPC B01F 27/2123; B01F 27/074; B01F 27/50

(57) ABSTRACT

A mixer includes: a first rotary shaft provided in a housing across a first end and a second end of the housing in one direction; and a first rotary body mounted on the first rotary shaft inside the housing, the first rotary body that conveys a material supplied from a supply port toward a discharge port while mixing the material as the first rotary shaft rotates. The first rotary body includes: a first main body including a first recessed portion recessed in a helical shape; and a plurality of first scrapers provided in the first recessed portion and arranged along the first recessed portion. Each first scraper has a first inclined surface inclined so as to press the material toward the discharge port by rotation of the first rotary shaft.

### CROSS-REFERENCE TO RELATED APPLICATION

This application claims the benefit of priority from Japanese Patent Application No. 2024-148620 filed with the Japan Patent Office on Aug. 30, 2024, the entire contents of which are incorporated herein by reference.

### TECHNICAL FIELD

The present disclosure relates to a mixer.

### BACKGROUND

A mixer in which a muller wheel revolves while rotating in a mixing tank to mix a material is known (for example, see Japanese Unexamined Utility Model Registration Application Publication No. 57-103125). In the mixer described in Japanese Unexamined Utility Model Registration Application Publication No. 57-103125, Multiple external forces are applied to the material by kneading (compressive force), smearing (shearing force), and spatulating (spatulate force), which are called the three actions of mulling, and mixing is performed.

### SUMMARY

The mixer described in Japanese Unexamined Utility Model Registration Application Publication No. 57-103125 performs a batch process in which the material supplied into the mixing tank is mixed and the mixed product is discharged from the mixing tank. In this technical field, it is desired to improve the efficiency of the mixing process. The present disclosure describes a mixer capable of improving the efficiency of mixing process.

A mixer according to one aspect of the present disclosure includes: a housing extending in one direction, the housing including a supply port provided at a first end portion in the one direction and a discharge port provided at a second end portion in the one direction; a first rotary shaft provided in the housing across a first end and a second end of the housing in the one direction; and a first rotary body mounted on the first rotary shaft inside the housing, the first rotary body that conveys a material supplied from the supply port toward the discharge port while mixing the material as the first rotary shaft rotates. The first rotary body includes: a first main body having a cylindrical shape and extending in the one direction, the first main body including a first recessed portion recessed in a helical shape, the helical shape advancing in a direction in which the material is conveyed by the first rotary body as the helical shape turns in a rotation direction of the first rotary shaft; and a plurality of first scrapers provided in the first recessed portion and arranged along the first recessed portion. Each of the plurality of first scrapers has a first inclined surface inclined so as to press the material toward the discharge port by rotation of the first rotary shaft. According to each aspect and each embodiment of the present disclosure, the efficiency of the mixing process can be improved.

### BRIEF DESCRIPTION OF THE DRAWINGS

FIG. 1 is a side view schematically showing a mixer according to an embodiment.

FIG. 2 is a plan view of the mixer shown in FIG. 1.

FIG. 3 is a cross-sectional view taken along line III-III of FIG. 2.

FIG. 4 is a plan view of a mixer including a rotation mechanism according to a modification.

### DETAILED DESCRIPTION

Hereinafter, embodiments of the present disclosure will be described in detail with reference to the drawings. In the description of the drawings, the same elements are denoted by the same reference numerals, and redundant description will be omitted. In each figure, an XYZ coordinate system may be shown. The Y-axis direction is a direction intersecting (for example, orthogonal to) the X-axis direction and the Z-axis direction. The Z-axis direction is a direction intersecting (for example, orthogonal to) the X-axis direction and the Y-axis direction. In the following description, for example, the X-axis direction is defined as the front-rear direction (one direction), the Y-axis direction is defined as the left-right direction, and the Z-axis direction is defined as the up-down direction (vertical direction). The X-axis direction, the Y-axis direction, and the Z-axis direction are not limited to the directions described above.

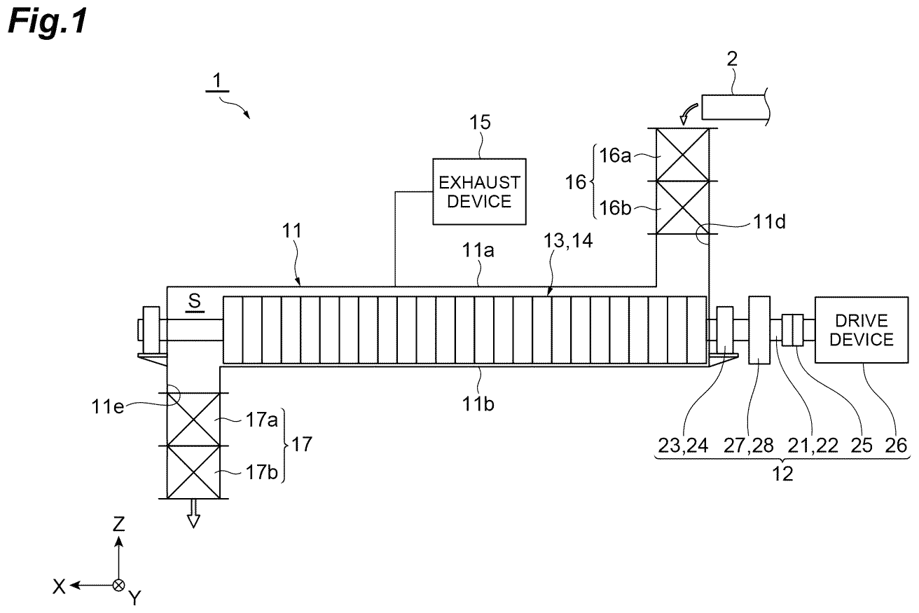

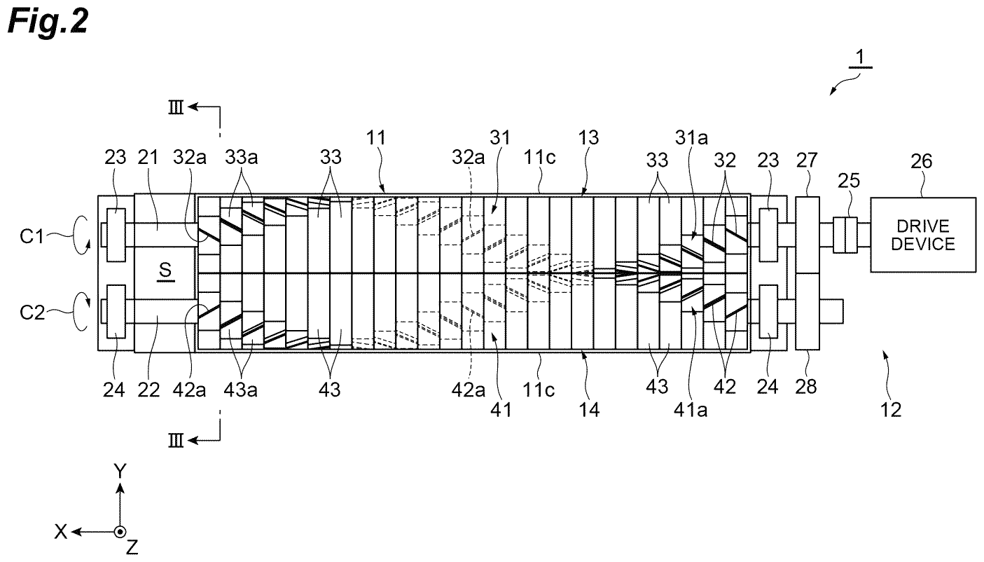

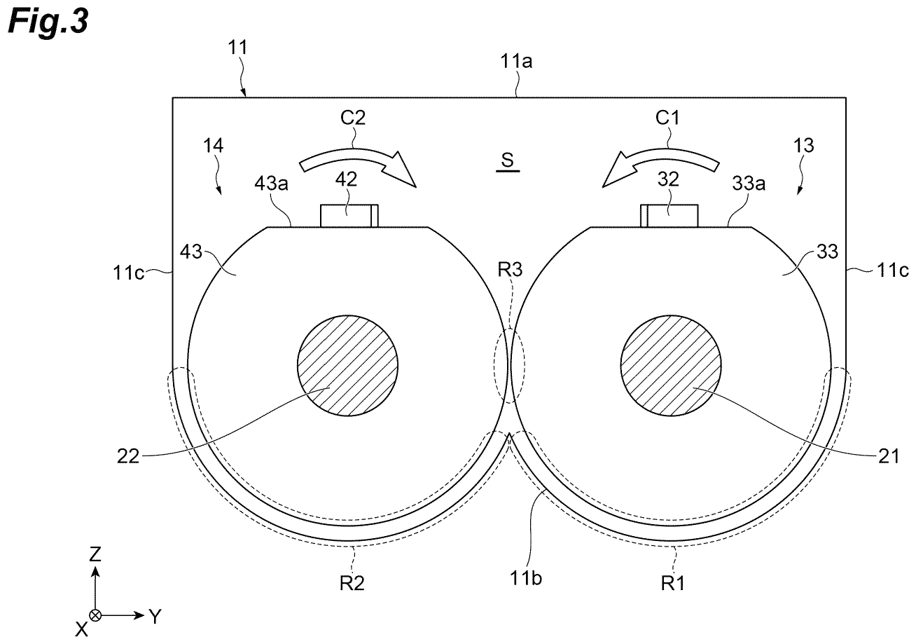

A mixer according to an embodiment will be described with reference to FIGS. 1 to 3. FIG. 1 is a side view schematically showing a mixer according to an embodiment. FIG. 2 is a plan view of the mixer shown in FIG. 1. FIG. 3 is a cross-sectional view taken along line III-III of FIG. 2. A mixer 1 shown in FIGS. 1 and 2 is a device for continuously mixing a material to be mixed. Examples of materials to be mixed include battery materials, ceramic materials, and chemical materials. A material is supplied to the mixer 1 from a supply device 2 provided above a supply port 11d described later. The supply device 2 may supply the material by a fixed amount. Materials may be supplied to the mixer 1 from two or more supply devices 2.

The mixer 1 includes a housing 11, a rotation mechanism 12, a rotary body 13 (first rotary body), and a rotary body 14 (second rotary body). Although the internal structure of the housing 11 is actually covered by the housing 11, the internal structure of the housing 11 is shown in FIGS. 1 and 2 for convenience of description.

The housing 11 extends in the front-rear direction. The housing 11 includes a top plate 11a, a bottom plate 11b, and a pair of side walls 11c which define an internal space S in which the material supplied from the supply device 2 is conveyed while being mixed. The bottom plate 11b has a shape conforming to the outer shapes of the rotary bodies 13 and 14. The cross-section of the bottom plate 11b taken along a plane intersecting the front-rear direction has a shape in which two downwardly convex arcs are connected side by side in the left-right direction. The supply port 11d for supplying a material to the internal space S is provided at the rear end portion (first end portion) of the housing 11. The supply port 11d is located below the supply device 2 and is open upward. A discharge port 11e for discharging the mixed product from the internal space S is provided at the front end portion (second end portion) of the housing 11. The discharge port 11e is open downward.

The rotation mechanism 12 is a mechanism for rotating the rotary body 13 and the rotary body 14. The rotation mechanism 12 includes a rotary shaft 21 (first rotary shaft), a rotary shaft 22 (second rotary shaft), a bearing 23, a bearing 24, a coupling 25, a drive device 26, a gear 27, and a gear 28.

The rotary shaft 21 and the rotary shaft 22 extend in the front-rear direction and are provided in the housing 11 across a one end (first end) and the other end (second end) of the housing 11 in the front-rear direction. The rotary shaft 21 and the rotary shaft 22 are arranged alongside each other in the left-right direction. The rotary shaft 21 and the rotary shaft 22 penetrate the housing 11 in the front-rear direction. The bearing 23 is a member for supporting the rotary shaft 21, and is provided outside the housing 11. In the present embodiment, a pair of bearings 23 are provided at both front and rear end portions of the rotary shaft 21. The bearing 24 is a member for supporting the rotary shaft 22, and is provided outside the housing 11. In the present embodiment, a pair of bearings 24 are provided at both front and rear end portions of the rotary shaft 22.

The drive shaft of the drive device 26 is connected to the rear end of the rotary shaft 21 via the coupling 25. The drive device 26 is, for example, a motor. The gear 27, which is a drive gear, is provided at the rear end portion of the rotary shaft 21. The gear 27 is fixed to the rotary shaft 21, and rotates around the axis of the rotary shaft 21 as the rotary shaft 21 rotates. The gear 28, which is a driven gear, is provided at the rear end portion of the rotary shaft 22. The gear 28 is fixed to the rotary shaft 22, and rotates around the axis of the rotary shaft 22 as the rotary shaft 22 rotates. The gear 27 and the gear 28 mesh with each other.

By the rotary shaft 21 being rotated by the drive device 26, the gear 28 is rotated by the gear 27, and the rotary shaft 22 is rotated. The number of teeth of the gear 27 may be the same as or different from the number of teeth of the gear 28. That is, the rotational speed (number of rotations) of the rotary shaft 21 may be the same as or different from the rotational speed (number of rotations) of the rotary shaft 22. The rotation direction C1 of the rotary shaft 21 is opposite to the rotation direction C2 of the rotary shaft 22. In the present embodiment, the rotation direction C1 is counterclockwise and the rotation direction C2 is clockwise when viewed from the rear.

The rotary body 13 is a member that is attached to the rotary shaft 21 inside the housing 11 and conveys the material supplied from the supply device 2 toward the discharge port 11e while mixing the material as the rotary shaft 21 rotates. The rotary body 13 is fixed to the rotary shaft 21, and rotates around the axis of the rotary shaft 21 as the rotary shaft 21 rotates. Specifically, the rotary body 13 includes a main body 31 (first main body) and a plurality of scrapers 32 (first scrapers).

The main body 31 has a cylindrical shape extending in the front-rear direction. The main body 31 includes a recessed portion 31a (first recessed portion). The recessed portion 31a is provided on the outer peripheral surface of the cylinder, and is recessed in a helical shape that advances in a direction (forward direction) in which the material is conveyed by the rotary body 13 as the helical shape turns on the outer peripheral surface in the rotation direction C1. That is, the winding direction of the recessed portion 31a is the same as the rotation direction C1. In the present embodiment, the recessed portion 31a is recessed in a left-handed helical shape that advances forward as the helical shape turns counterclockwise on the outer peripheral surface.

More specifically, the main body 31 includes a plurality of divided rolls 33 (first divided rolls). Each divided roll 33 is a cylindrical roll having a central axis in the front-rear direction. Each divided roll 33 includes a missing portion 33a where the outer peripheral surface of the cylinder is missing over the entire length of the divided roll 33 in the front-rear direction. The missing portion 33a is, for example, a portion in which the outer peripheral surface of the cylinder is recessed flatly along the central axis of the cylinder. The plurality of divided rolls 33 are coaxially arranged in the front-rear direction and fixed to the rotary shaft 21, and rotate around the axis of the rotary shaft 21 as the rotary shaft 21 rotates. The outer peripheral surface of each divided roll 33 is separated from the bottom plate 11b by a predetermined distance. A region R1 is formed between the outer peripheral surface of the divided roll 33 and the bottom plate 11b of the housing 11.

The plurality of divided rolls 33 are arranged such that, in any two divided rolls 33 adjacent to each other in the front-rear direction, the missing portion 33a of the front divided roll 33 is offset from the missing portion 33a of the rear divided roll 33 by a predetermined angle (15° in the present embodiment) in the rotation direction C1. When viewed from the front-rear direction, the position on the circumference (outer peripheral surface) of the front divided roll 33 where the missing portion 33a is provided and the position on the circumference (outer peripheral surface) of the rear divided roll 33 where the missing portion 33a is provided are partially overlapped with each other. In this manner, the main body 31 is formed by arranging the plurality of divided rolls 33 in the front-rear direction without any gaps, and the helical recessed portion 31a is formed by the missing portions 33a of the plurality of divided rolls 33.

The plurality of scrapers 32 are provided in the recessed portion 31a and are arranged along the recessed portion 31a. Specifically, the scraper 32 is provided in the missing portion 33a of the divided roll 33. A single scraper 32 is provided in each missing portion 33a. Each scraper 32 has an inclined surface 32a (first inclined surface). The inclined surface 32a is inclined so as to press the material toward the discharge port 11e by the rotation of the rotary shaft 21.

Specifically, the inclined surface 32a is inclined with respect to the conveying direction and is inclined with respect to the tangential direction of the rotation direction C1 at the position where the scraper 32 is provided. The inclined surface 32a is oriented in the rotation direction C1 and in the conveying direction. In other words, the inclined surface 32a is oriented in a direction obtained by combining the conveying direction and the tangential direction of the rotation direction C1 at the position where the scraper 32 is provided. The inclination angles of the inclined surfaces 32a of the scrapers 32 may be the same as or different from each other.

In the present embodiment, each scraper 32 has a plate-like shape and is erected on the missing portion 33a. Each scraper 32 protrudes from the missing portion 33a so that the corner portions at both ends of the scraper 32 are positioned concentrically with the outer peripheral surface of the divided roll 33. In any two scrapers 32 adjacent to each other in the front-rear direction, the rear end of the front scraper 32 is provided at a position advanced in the rotation direction C1 from the front end of the rear scraper 32. The rear end of the front scraper 32 is substantially at the same position as the front end of the rear scraper 32 in the front-rear direction. The front end of the rear scraper 32 may be located in front of the rear end of the front scraper 32.

With this configuration, when the rear scraper 32 moves along the bottom plate 11b, the material is supplied behind the front scraper 32 (the side opposite to the inclined surface 32a) in the space between the missing portion 33a of the front divided roll 33 and the bottom plate 11b by the inclined surface 32a. As long as the scraper 32 has the inclined surface 32a, the shape of the scraper 32 is not limited to a plate-like shape.

The rotary body 14 is a member that is attached to the rotary shaft 22 inside the housing 11 and conveys the material supplied from the supply device 2 toward the discharge port 11e while mixing the material as the rotary shaft 22 rotates. The rotary body 14 is fixed to the rotary shaft 22, and rotates around the axis of the rotary shaft 22 as the rotary shaft 22 rotates. Specifically, the rotary body 14 includes a main body 41 (second main body) and a plurality of scrapers 42 (second scrapers).

The main body 41 has a cylindrical shape extending in the front-rear direction. The main body 41 includes a recessed portion 41a (second recessed portion). The recessed portion 41a is provided on the outer peripheral surface of the cylinder, and is recessed in a helical shape that advances in a direction (forward direction) in which the material is conveyed by the rotary body 14 as the helical shape turns on the outer peripheral surface in the rotation direction C2. That is, the winding direction of the recessed portion 41a is the same as the rotation direction C2. In the present embodiment, the recessed portion 41a is recessed in a right-handed helical shape that advances forward as the helical shape turns clockwise on the outer peripheral surface.

More specifically, the main body 41 includes a plurality of divided rolls 43 (second divided rolls). Each divided roll 43 is a cylindrical roll having a central axis in the front-rear direction. Each divided roll 43 includes a missing portion 43a where the outer peripheral surface of the cylinder is missing over the entire length of the divided roll 43 in the front-rear direction. The missing portion 43a is, for example, a portion in which the outer peripheral surface of the cylinder is recessed flatly along the central axis of the cylinder. The plurality of divided rolls 43 are coaxially arranged in the front-rear direction and fixed to the rotary shaft 22, and rotate around the axis of the rotary shaft 22 as the rotary shaft 22 rotates. The outer peripheral surface of each divided roll 43 is separated from the bottom plate 11b by a predetermined distance. A region R2 is formed between the outer peripheral surface of the divided roll 43 and the bottom plate 11b of the housing 11.

The plurality of divided rolls 43 are arranged such that, in any two divided rolls 43 adjacent to each other in the front-rear direction, the missing portion 43a of the front divided roll 43 is offset from the missing portion 43a of the rear divided roll 43 by a predetermined angle (15° in the present embodiment) in the rotation direction C2. When viewed from the front-rear direction, the position on the circumference (outer peripheral surface) of the front divided roll 43 where the missing portion 43a is provided and the position on the circumference (outer peripheral surface) of the rear divided roll 43 where the missing portion 43a is provided are partially overlapped with each other. In this manner, the main body 41 is formed by arranging the plurality of divided rolls 43 in the front-rear direction without any gaps, and the helical recessed portion 41a is formed by the missing portions 43a of the plurality of divided rolls 43.

The plurality of scrapers 42 are provided in the recessed portion 41a and are arranged along the recessed portion 41a. Specifically, the scraper 42 is provided in the missing portion 43a of the divided roll 43. A single scraper 42 is provided in each missing portion 43a. Each scraper 42 has an inclined surface 42a (second inclined surface). The inclined surface 42a is inclined so as to press the material toward the discharge port 11e by the rotation of the rotary shaft 22.

Specifically, the inclined surface 42a is inclined with respect to the conveying direction and is inclined with respect to the tangential direction of the rotation direction C2 at the position where the scraper 42 is provided. The inclined surface 42a is oriented in the rotation direction C2 and in the conveying direction. In other words, the inclined surface 42a is oriented in a direction obtained by combining the conveying direction and the tangential direction of the rotation direction C2 at the position where the scraper 42 is provided. The inclination angles of the inclined surfaces 42a of the scrapers 42 may be the same as or different from each other.

In the present embodiment, each scraper 42 has a plate-like shape and is erected on the missing portion 43a. Each scraper 42 protrudes from the missing portion 43a so that the corner portions at both ends of the scraper 42 are positioned concentrically with the outer peripheral surface of the divided roll 43. In any two scrapers 42 adjacent to each other in the front-rear direction, the rear end of the front scraper 42 is provided at a position advanced in the rotation direction C2 from the front end of the rear scraper 42. The rear end of the front scraper 42 is substantially at the same position as the front end of the rear scraper 42 in the front-rear direction. The front end of the rear scraper 42 may be located in front of the rear end of the front scraper 42.

With this configuration, when the rear scraper 42 moves along the bottom plate 11b, the material is supplied behind the front scraper 42 (the side opposite to the inclined surface 42a) in the space between the missing portion 43a of the front divided roll 43 and the bottom plate 11b by the inclined surface 42a. As long as the scraper 42 has the inclined surface 42a, the shape of the scraper 42 is not limited to a plate-like shape.

In the present embodiment, the rotary body 13 and the rotary body 14 are configured symmetrically. That is, the rotary bodies 13 and 14 are symmetrical with respect to a symmetrical plane perpendicular to the left-right direction, which is located between the rotary bodies 13 and 14. The rotary body 13 and the rotary body 14 may also be configured asymmetrically. The outer peripheral surface of the divided roll 33 and the outer peripheral surface of the divided roll 43 are spaced apart from each other in the left-right direction by a distance sufficient to allow the material to pass through. A region R3 is formed between the outer peripheral surface of the divided roll 33 and the outer peripheral surface of the divided roll 43, which face each other in the left-right direction.

The mixer 1 further includes an exhaust device 15, a double damper 16, and a double damper 17. The exhaust device 15 is connected to the housing 11, and discharges gas from the inside of the housing 11 (internal space S), thereby bringing the internal space S into a negative pressure state. The exhaust device 15 is, for example, a vacuum pump.

The double damper 16 is provided at the supply port 11d. The double damper 16 includes a valve body 16a and a valve body 16b provided in the up-down direction. The double damper 16 supplies the material supplied from the supply device 2 to the internal space S while maintaining the airtightness of the internal space S by alternately opening and closing the valve body 16a and the valve body 16b.

The double damper 17 is provided at the discharge port 11e. The double damper 17 includes a valve body 17a and a valve body 17b provided in the up-down direction. The double damper 17 discharges the mixed product from the internal space S while maintaining the airtightness of the internal space S by alternately opening and closing the valve body 17a and the valve body 17b.

Next, the operation of the mixer 1 will be described with reference to FIGS. 1 to 3. Here, vacuum mixing will be described. First, the exhaust device 15 is activated, and the internal space S is depressurized to be set to a negative pressure state. The valve body 16a is set to an open state, and the valve body 16b is set to a closed state. The valve body 17a is set to an open state, and the valve body 17b is set to a closed state.

Then, the drive device 26 is activated. By the rotary shaft 21 being rotated by the drive device 26, the gear 28 is rotated by the gear 27, and the rotary shaft 22 is rotated. As a result, the rotary shaft 21 and the rotary shaft 22 rotate in opposite directions to each other. Specifically, the rotary shaft 21 rotates in the rotation direction C1, and the rotary shaft 22 rotates in the rotation direction C2.

Subsequently, the supply device 2 supplies the material by a fixed amount. At this time, since the valve body 16a is set to the open state and the valve body 16b is set to the closed state, the material supplied from the supply device 2 is accommodated in the double damper 16 while the negative pressure state of the internal space S is maintained. By setting the valve body 16a to the closed state and the valve body 16b to the open state, the material accommodated in the double damper 16 is supplied from the supply port 11d to the internal space S while the negative pressure state of the internal space S is maintained.

Subsequently, the material supplied to the internal space S passes between the divided roll 33 and the divided roll 43 located below the supply port 11d and moves to the bottom portion of the housing 11. The rotary body 13 and the rotary body 14 apply a compressive force, a shearing force, and a spatulate force to the material deposited on the bottom portion of the housing 11, thereby mixing (mulling) the material.

Specifically, since the material is sandwiched between the outer peripheral surface of the divided roll 33 and the bottom plate 11b of the housing 11 (region R1), a compressive force is applied to the material in the region R1. At this time, since the housing 11 is stationary and the divided roll 33 is rotating, a speed difference is generated between the bottom plate 11b and the outer peripheral surface of the divided roll 33. Due to this speed difference, a shearing force is applied to the material in the region R1. Similarly, since the material is sandwiched between the outer peripheral surface of the divided roll 43 and the bottom plate 11b (region R2), a compressive force is applied to the material in the region R2. At this time, a shearing force is applied to the material in the region R2 due to a speed difference generated between the bottom plate 11b and the outer peripheral surface of the divided roll 43.

Since the material is also sandwiched between the outer peripheral surface of the divided roll 33 and the outer peripheral surface of the divided roll 43, which face each other in the left-right direction (region R3), a compressive force is applied to the material in the region R3. At this time, when the rotational speed of the rotary shaft 21 and the rotational speed of the rotary shaft 22 are different from each other, a speed difference is generated between the outer peripheral surface of the divided roll 33 and the outer peripheral surface of the divided roll 43. Due to this speed difference, a shearing force is applied to the material in the region R3.

Since the material is pressed forward toward the discharge port 11e by the inclined surface 32a of each scraper 32, the material is sandwiched between the outer peripheral surface of the divided roll 33 and the bottom plate 11b while being conveyed forward in the region R1. At this time, the material and the outer peripheral surface of the divided roll 33 relatively move in the front-rear direction. That is, the divided roll 33 slides relative to the material. Thus, a spatulate force is applied to the material in the region R1. Similarly, since the material is pressed forward toward the discharge port 11e by the inclined surface 42a of each scraper 42, the material is sandwiched between the outer peripheral surface of the divided roll 43 and the bottom plate 11b while being conveyed forward in the region R2. At this time, since the divided roll 43 slides relatively to the material, a spatulate force is applied to the material in the region R2.

Then, the material between the divided roll 33 and the bottom plate 11b is scraped by the scraper 32, and, while being disintegrated, is supplied by the scraper 32 to the space between the missing portion 33a of the preceding divided roll 33 and the bottom plate 11b. Since the plurality of scrapers 32 are arranged in a helical shape that advances forward as the helical shape turns in the rotation direction C1, the material scraped by the scraper 32 is supplied behind the preceding scraper 32 (the side opposite to the inclined surface 32a). As a result, the material is moved to the next divided roll 33 after being subjected to a compressive force, a shearing force, and a spatulate force by the divided roll 33.

Similarly, the material between the divided roll 43 and the bottom plate 11b is scraped by the scraper 42, and, while being disintegrated, is supplied by the scraper 42 to the space between the missing portion 43a of the preceding divided roll 43 and the bottom plate 11b. Since the plurality of scrapers 42 are arranged in a helical shape that advances forward as the helical shape turns in the rotation direction C2, the material scraped by the scraper 42 is supplied behind the preceding scraper 42 (the side opposite to the inclined surface 42a). As a result, the material is moved to the next divided roll 43 after being subjected to a compressive force, a shearing force, and a spatulate force by the divided roll 43.

While the above operations are repeated, the material is conveyed forward while being mixed, and a mixed product is produced. The mixed product that has reached the foremost divided roll 33 and the foremost divided roll 43 is discharged from the discharge port 11e. At this time, since the valve body 17a is set to the open state and the valve body 17b is set to the closed state, the mixed product discharged from the discharge port 11e is accommodated in the double damper 17 while the negative pressure state of the internal space S is maintained. By setting the valve body 17a to the closed state and the valve body 17b to the open state, the mixed product accommodated in the double damper 17 is discharged to the outside of the mixer 1 while the negative pressure state of the internal space S is maintained.

In the mixer 1 described above, the material supplied from the supply port 11d to the internal space S of the housing 11 is conveyed toward the discharge port 11e while being mixed by the rotary body 13 as the rotary shaft 21 rotates. When the rotary body 13 rotates with the rotation of the rotary shaft 21, the material is sandwiched between the outer peripheral surface of the cylindrical portion of the main body 31 and the housing 11, so that a compressive force is applied to the material. At this time, since a speed difference is generated between the stationary housing 11 and the outer peripheral surface of the rotating main body 31, a shearing force is applied to the material between the outer peripheral surface of the main body 31 and the housing 11. Further, since the material is pressed toward the discharge port 11e by the inclined surface 32a of the scraper 32, the material is sandwiched between the outer peripheral surface of the main body 31 and the housing 11 while moving to the discharge port 11e. At this time, a spatulate force is applied to the material.

In the mixer 1, the plurality of scrapers 32 are provided along the recessed portion 31a which is recessed in a helical shape that advances in the conveying direction as the helical shape turns in the rotation direction C1. Therefore, as the rotary shaft 21 rotates, the material is supplied behind the preceding scraper 32 by the inclined surface 32a of the scraper 32. As a result, the material is conveyed toward the discharge port 11e while being subjected to a compressive force, a shearing force, and a spatulate force, and is discharged from the discharge port 11e. Therefore, the mixing process can be carried out continuously while maintaining the three actions of the mulling. As a result, the efficiency of the mixing process can be improved.

Similarly, the material supplied from the supply port 11d to the internal space S of the housing 11 is conveyed toward the discharge port 11e while being mixed by the rotary body 14 as the rotary shaft 22 rotates. When the rotary body 14 rotates with the rotation of the rotary shaft 22, the material is sandwiched between the outer peripheral surface of the cylindrical portion of the main body 41 and the housing 11, so that a compressive force is applied to the material. At this time, since a speed difference is generated between the stationary housing 11 and the outer peripheral surface of the rotating main body 41, a shearing force is applied to the material between the outer peripheral surface of the main body 41 and the housing 11. Further, since the material is pressed toward the discharge port 11e by the inclined surface 42a of the scraper 42, the material is sandwiched between the outer peripheral surface of the main body 41 and the housing 11 while moving to the discharge port 11e. At this time, a spatulate force is applied to the material. Further, a compressive force is also applied to the material between the outer peripheral surface of the rotary body 13 (divided roll 33) and the outer peripheral surface of the rotary body 14 (divided roll 43), which face each other in the left-right direction.

In the mixer 1, the plurality of scrapers 42 are provided along the recessed portion 41a which is recessed in a helical shape that advances in the conveying direction as the helical shape turns in the rotation direction C2. Therefore, as the rotary shaft 22 rotates, the material is supplied behind the preceding scraper 42 by the inclined surface 42a of the scraper 42. As a result, the material is conveyed toward the discharge port 11e while being subjected to a compressive force, a shearing force, and a spatulate force, and is discharged from the discharge port 11e. Therefore, the mixing process can be carried out continuously while maintaining the three actions of the mulling. As described above, the efficiency of the mixing process can be further improved by the rotary bodies 13 and 14 arranged alongside each other.

The rotary body 13 is manufactured simply by arranging the plurality of divided rolls 33, each of which is provided with the scraper 32, in the front-rear direction. Similarly, the rotary body 14 is manufactured by simply arranging the plurality of divided rolls 43, each of which is provided with the scraper 42, in the front-rear direction. Therefore, the manufacture of the mixer 1 can be simplified.

When the scraper 32 moves along the bottom plate 11b, the material is supplied behind the next scraper 32 in the space between the missing portion 33a of the next divided roll 33 and the bottom plate 11b by the inclined surface 32a. Therefore, the material is moved to the next divided roll 33 after being subjected to a compressive force, a shearing force, and a spatulate force by the divided roll 33. Accordingly, the material is not conveyed without being sufficiently mixed, and the material can be conveyed while performing uniform mixing. Similarly, when the scraper 42 moves along the bottom plate 11b, the material is supplied behind the next scraper 42 in the space between the missing portion 43a of the next divided roll 43 and the bottom plate 11b by the inclined surface 42a. Therefore, the material is moved to the next divided roll 43 after being subjected to a compressive force, a shearing force, and a spatulate force by the divided roll 43. Accordingly, the material can be conveyed while performing uniform mixing.

When the rotational speed of the rotary shaft 21 is different from the rotational speed of the rotary shaft 22, a speed difference is generated between the outer peripheral surface of the divided roll 33 and the outer peripheral surface of the divided roll 43 which face each other in the left-right direction. Therefore, a shearing force is also applied to the material between the outer peripheral surface of the divided roll 33 and the outer peripheral surface of the divided roll 43, which face each other (region R3). Therefore, the shearing effect can be improved.

In the mixer 1, a portion of the rotation mechanism 12 excluding the rotary shaft 21 and the rotary shaft 22 is provided outside the housing 11. Therefore, since the structure of the mixer 1 is relatively simple, cleaning and maintenance can be easily performed. Accordingly, the maintainability of the mixer 1 can be improved. In other words, the time and cost required for the maintenance of the mixer 1 can be reduced.

In the mixer 1, the bearings 23 and 24 are provided outside the housing 11. This makes it possible to reduce the possibility of contamination in which foreign matters, such as grease applied to the bearings 23 and 24 and metal wear particles that may be generated in the bearings 23 and 24, are mixed into the material in the internal space S.

When a material having a low bulk density such as a powder is supplied from the supply device 2, the material may not be sandwiched between the inner surface of the housing 11 and the outer peripheral surface of the divided roll 33. Similarly, a material may not be sandwiched between the inner surface of the housing 11 and the outer peripheral surface of the divided roll 43. On the other hand, in the mixer 1, since the material is adhered to the inner surface of the housing 11 by bringing the internal space S into a negative pressure state by the exhaust device 15, the material is easily sandwiched between the inner surface of the housing 11 and the outer peripheral surface of the divided roll 33 (or the divided roll 43). As a result, a compressive force, a shearing force, and a spatulate force can be more reliably applied to the material, so that the efficiency of the mixing process can be further improved. The mixer according to the present disclosure is not limited to the above embodiments.

The main body 31 may be constituted by one roll instead of the plurality of divided rolls 33. Similarly, the main body 41 may be constituted by one roll instead of the plurality of divided rolls 43.

The mixer 1 is not required to include the rotary body 14. In this case, the rotation mechanism 12 is not required to include the rotary shaft 22, the bearing 24, the gear 27, and the gear 28.

As long as vacuum mixing is not performed, the mixer 1 is not required to include the exhaust device 15, the double damper 16, and the double damper 17.

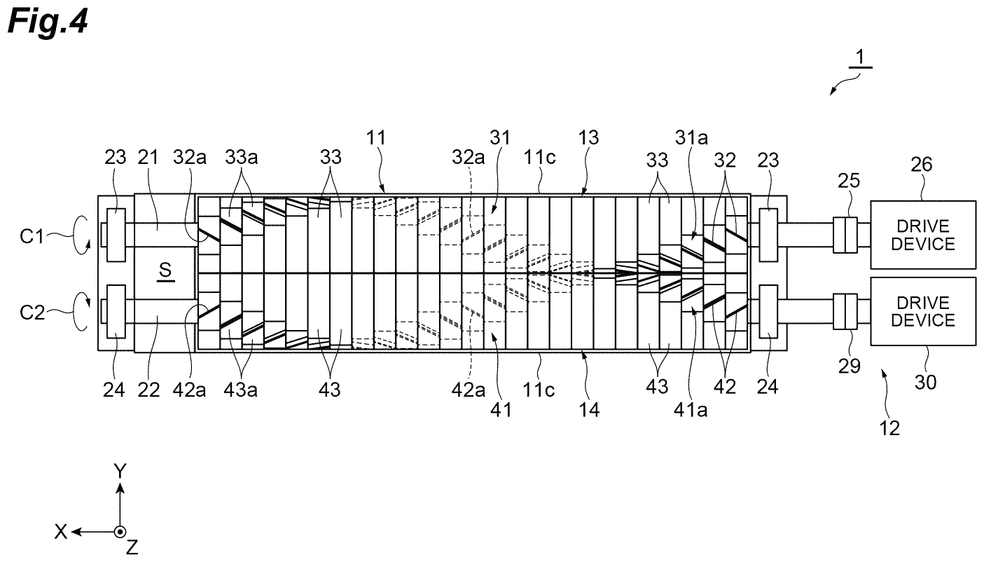

The rotation mechanism 12 may independently drive the rotary body 13 and the rotary body 14 to rotate. For example, as shown in FIG. 4, the rotation mechanism 12 includes a coupling 29 and a drive device 30 in place of the gears 27 and 28. The drive shaft of the drive device 30 is connected to the rear end of the rotary shaft 22 via the coupling 29. The drive device 30 is, for example, a motor.

In this case, the rotary shaft 21 is rotated by the drive device 26, and the rotary shaft 22 is rotated by the drive device 30. That is, the rotary shaft 21 (the rotary body 13) and the rotary shaft 22 (the rotary body 14) are driven to rotate independently. Therefore, the rotary shaft 21 and the rotary shaft 22 can be set to the same rotational speed or to different rotational speeds. Furthermore, the rotation direction C1 and the rotation direction C2 can be set to the same direction or to different directions. Therefore, a variety of mixing patterns can be realized. By repeatedly and alternately setting the rotation direction of each rotary shaft to clockwise and counterclockwise, the material can be retained in the internal space S, and the mixing time can be increased.

Any reference to elements using designations such as “first” and “second” as used in the present disclosure does not generally limit the amount or order of those elements. These designations may be used in the present disclosure as a convenient way of distinguishing between two or more elements. Thus, references to the first and second elements do not imply that only two elements may be adopted, or that the first element must precede the second element in any way. It does not presuppose the presence of the second element when the first element is used alone, nor does it presuppose the presence of the first element when the second element is used alone.

Finally, an overview of embodiments of the present disclosure will be described.

### Clause 1

A mixer comprising:
a housing extending in one direction, the housing including a supply port provided at a first end portion in the one direction and a discharge port provided at a second end portion in the one direction;
a first rotary shaft provided in the housing across a first end and a second end of the housing in the one direction; and
a first rotary body mounted on the first rotary shaft inside the housing, the first rotary body being configured to convey a material supplied from the supply port toward the discharge port while mixing the material as the first rotary shaft rotates,
wherein the first rotary body comprises:
   a first main body having a cylindrical shape and extending in the one direction, the first main body including a first recessed portion recessed in a helical shape, the helical shape advancing in a direction in which the material is conveyed by the first rotary body as the helical shape turns in a rotation direction of the first rotary shaft; and
   a plurality of first scrapers provided in the first recessed portion and arranged along the first recessed portion, and
wherein each of the plurality of first scrapers has a first inclined surface inclined so as to press the material toward the discharge port by rotation of the first rotary shaft.

### Clause 2

The mixer according to clause 1, wherein the first main body includes a plurality of first divided rolls arranged in the one direction, and
wherein the plurality of first scrapers are respectively provided on the plurality of first divided rolls.

### Clause 3

The mixer according to clause 1 or 2, further comprising:
a second rotary shaft provided in the housing across the first end and the second end of the housing in the one direction and arranged alongside the first rotary shaft; and
a second rotary body mounted on the second rotary shaft inside the housing, the second rotary body being configured to convey the material toward the discharge port while mixing the material as the second rotary shaft rotates,
wherein the second rotary body comprises:
   a second main body having a cylindrical shape and extending in the one direction, the second main body including a second recessed portion recessed in a helical shape, the helical shape advancing in a direction in which the material is conveyed by the second rotary body as the helical shape turns in a rotation direction of the second rotary shaft; and
   a plurality of second scrapers provided in the second recessed portion and arranged along the second recessed portion, and
wherein each of the plurality of second scrapers has a second inclined surface inclined so as to press the material toward the discharge port by rotation of the second rotary shaft.

### Clause 4

The mixer according to clause 3, wherein the second main body includes a plurality of second divided rolls arranged in the one direction, and
wherein the plurality of second scrapers are respectively provided on the plurality of second divided rolls.

### Clause 5

The mixer according to clause 3 or 4, wherein a rotational speed of the first rotary shaft is different from a rotational speed of the second rotary shaft.

### clause 6

The mixer according to any one of clauses 1 to 5, further comprising a bearing provided outside the housing and supporting the first rotary shaft.

In the mixer according to clause 1, the material supplied from the supply port is conveyed toward the discharge port while being mixed by the first rotary body as the first rotary shaft rotates. When the first rotary body rotates with the rotation of the first rotary shaft, the material is sandwiched between the outer peripheral surface of the cylindrical portion of the first main body and the housing, so that a compressive force is applied to the material. At this time, since a speed difference is generated between the housing in a stationary state and the outer peripheral surface of the first main body which is rotating, a shearing force is applied to the material between the outer peripheral surface of the first main body and the housing. Further, since the material is pressed toward the discharge port by the first inclined surface of the first scraper, the material is sandwiched between the outer peripheral surface of the first main body and the housing while moving to the discharge port. At this time, a spatulate force is applied to the material.

In the above-mentioned mixer, the plurality of first scrapers are provided along the recessed portion which is recessed in a helical shape that advances in the conveying direction of the first rotary body as the helical shape turns in the rotation direction of the first rotary shaft. Therefore, as the first rotary shaft rotates, the material is supplied behind the first scraper adjacent in the conveying direction by the first inclined surface of the first scraper. As a result, the material is sequentially conveyed toward the discharge port while being subjected to a compressive force, a shearing force, and a spatulate force, and is discharged from the discharge port. Therefore, the mixing process can be carried out continuously while maintaining the three actions of the mulling. As a result, the efficiency of the mixing process can be improved.

In the mixer according to clause 2, the first rotary body is manufactured by simply arranging the plurality of first divided rolls, each of which is provided with the first scraper, in the one direction. Therefore, the manufacture of the mixer can be simplified.

In the mixer according to clause 3, the material supplied from the supply port is conveyed toward the discharge port while being mixed by the second rotary body as the second rotary shaft rotates. Therefore, the mixing process can be carried out continuously by the second rotary body as well as by the first rotary body, while maintaining the three actions of the mulling. As a result, the efficiency of the mixing process can be further improved.

In the mixer according to clause 4, the second rotary body is manufactured by simply arranging the plurality of second divided rolls, each of which is provided with the second scraper, in the one direction. Therefore, the manufacture of the mixer can be simplified.

In the mixer according to clause 5, a speed difference is generated between the outer peripheral surface of the first main body and the outer peripheral surface of the second main body, which face each other. Therefore, a shearing force is also applied to the material between the outer peripheral surface of the first main body and the outer peripheral surface of the second main body, which face each other. Therefore, the shearing effect can be improved.

In the mixer according to clause 6, since the bearing is provided outside the housing, it is possible to reduce the possibility that foreign matters, such as grease applied to the bearing and metal wear particles that may be generated in the bearing, are mixed into the material.

What is claimed is:

1. A mixer comprising:
a housing extending in one direction, the housing including a supply port provided at a first end portion in the one direction and a discharge port provided at a second end portion in the one direction;
a first rotary shaft provided in the housing across a first end and a second end of the housing in the one direction; and
a first rotary body mounted on the first rotary shaft inside the housing, the first rotary body being configured to convey a material supplied from the supply port toward the discharge port while mixing the material as the first rotary shaft rotates,
wherein the first rotary body comprises:
a first main body having a cylindrical shape and extending in the one direction, the first main body including a first recessed portion recessed in a helical shape, the helical shape advancing in a direction in which the material is conveyed by the first rotary body as the helical shape turns in a rotation direction of the first rotary shaft; and
a plurality of first scrapers provided in the first recessed portion and arranged along the first recessed portion, and
wherein each of the plurality of first scrapers has a first inclined surface inclined so as to press the material toward the discharge port by rotation of the first rotary shaft.

2. The mixer according to claim 1, wherein the first main body includes a plurality of first divided rolls arranged in the one direction, and
wherein the plurality of first scrapers are respectively provided on the plurality of first divided rolls.

3. The mixer according to claim 1, further comprising:
a second rotary shaft provided in the housing across the first end and the second end of the housing in the one direction and arranged alongside the first rotary shaft; and
a second rotary body mounted on the second rotary shaft inside the housing, the second rotary body being configured to convey the material toward the discharge port while mixing the material as the second rotary shaft rotates,
wherein the second rotary body comprises:
a second main body having a cylindrical shape and extending in the one direction, the second main body including a second recessed portion recessed in a helical shape, the helical shape advancing in a direction in which the material is conveyed by the second rotary body as the helical shape turns in a rotation direction of the second rotary shaft; and
a plurality of second scrapers provided in the second recessed portion and arranged along the second recessed portion, and
wherein each of the plurality of second scrapers has a second inclined surface inclined so as to press the material toward the discharge port by rotation of the second rotary shaft.

4. The mixer according to claim 3, wherein the second main body includes a plurality of second divided rolls arranged in the one direction, and
wherein the plurality of second scrapers are respectively provided on the plurality of second divided rolls.

5. The mixer according to claim 3, wherein a rotational speed of the first rotary shaft is different from a rotational speed of the second rotary shaft.

6. The mixer according to claim 1, further comprising a bearing provided outside the housing and supporting the first rotary shaft.
